(19) United States
(12) Patent Application Publication
(10) Pub. No.: US 2012/0218272 A1
(43) Pub. Date: Aug. 30, 2012

(54) METHOD AND APPARATUS FOR GENERATING TEXT IN TERMINAL

(75) Inventors: Myung Geun KOH, Suwon-si (KR); Yi Kyu MIN, Youngin-si (KR); Kyung Goo LEE, Seoul (KR); Byoung Il SON, Suwon-si (KR)

(73) Assignee: SAMSUNG ELECTRONICS CO. LTD., Suwon-si (KR)

(21) Appl. No.: 13/188,889

(22) Filed: Jul. 22, 2011

(30) Foreign Application Priority Data
Feb. 25, 2011 (KR) 10-2011-0017304

(51) Int. Cl. G06T 11/00

(52) U.S. Cl. 345/467

(57) ABSTRACT

A method and an apparatus for generating a text in a terminal are provided. The method includes displaying a soft key pad comprising soft keys on a text generating screen while in a text generating mode, the soft keys being elliptically arranged in a ring arrangement on the soft key pad, and generating a text comprising a character allotted to a soft key through a drag when the drag is determined to pass through the soft key. As the soft keys are elliptically arranged in the terminal, a terminal user may continuously and easily select soft keys to which desired characters are allotted.

### PRIORITY

This application claims the benefit under 35 U.S.C. §119(a) of a Korean patent application filed on Feb. 25, 2011 in the Korean Intellectual Property Office and assigned Serial No. 10-2011-0017304, the entire disclosure of which is hereby incorporated by reference.

### BACKGROUND OF THE INVENTION

1. Field of the Invention

The present invention relates to a terminal. More particularly, the present invention relates to a method for generating a text in a terminal and an apparatus thereof.

2. Description of the Related Art

In general, a terminal executes various complex functions. The terminal includes an input unit such as a keyboard or a mouse for executing the various types of functions. However, the terminal has problems in that portability can be difficult, a separate installation space for the input unit may be required, and maintenance can be difficult. Accordingly, to address the above problems, a conventional terminal may include a touch screen instead of a keyboard or a mouse as the input unit. That is, the terminal displays a key pad composed of a plurality of character keys on a touch screen in a character input mode. The terminal senses a touch on the touch screen to generate a text. More particularly, recently, as modern mobile terminals are developed, generating texts using a touch screen has become common.

However, because the foregoing terminal arranges character keys according to a preset pattern to display the key pad, it deteriorates convenience for a user of the terminal. Specifically, upon displaying the key pad, a terminal user may have difficulty in repeatedly touching desired character keys. As character keys required by the terminal user are often spaced apart from each other on the key pad, the foregoing difficulty is increased. This prevents a user from easily creating a desired text in the terminal.

### SUMMARY OF THE INVENTION

Aspects of the present invention are to address at least the above-mentioned problems and/or disadvantages and to provide at least the advantages described below. Accordingly, an aspect of the present invention is to provide a terminal that allows a user to easily create a text.

In accordance with an aspect of the present invention, a method for generating a text in a terminal is provided. The method includes displaying a soft key pad comprising soft keys on a text generating screen while in a text generating mode, the soft keys being elliptically arranged in a ring arrangement on the soft key pad, and generating a text comprising a character allotted to a soft key through a dragging motion when a drag path of the dragging motion is determined to pass through the soft key.

The displaying of the soft key pad may include separating and arranging soft keys into at least two rings in a form of concentric circles. The displaying of the soft key pad may include spacing the soft keys apart from each other to provide a passing area of the drag between the soft keys. The generating of the text may include generating the text comprising a character allotted to a selected soft key when a touch for selecting the soft key is detected from the soft key pad. The generating of the text may include creating a word comprising characters allotted to soft keys passed through on the drag path when a drop of the dragging motion occurs on the text generating screen, and repeating the generation of another word when another drag occurs on the soft key pad. The generating of the text comprises executing an additional function set corresponding to a moving direction of the drag path when the dragging motion moves in a center area of the soft key pad in a predetermined direction, wherein the additional function comprises one of a spacing function, a backspace function, and a function for converting types of characters allotted to the soft keys.

In accordance with another aspect of the present invention, an apparatus for generating a text in a terminal is provided. The apparatus includes a display unit for displaying a soft key pad comprising soft keys on a text generating screen while in a text generating mode, the soft keys being elliptically arranged in a ring arrangement on the soft key pad, a touch panel for sensing a drag passing through a soft key on the soft key pad, and a controller for generating a text comprising a character allotted to the soft key passed through by the drag.

The display unit may separate and arrange soft keys into at least two rings in a form of concentric circles under control of the controller. The display unit may space the soft keys apart from each other to provide a passing area of the drag between the soft keys. The controller may generate the text comprising a character allotted to a selected soft key when a touch for selecting the selected soft key is detected from the soft key pad. The controller may create a word comprising characters allotted to soft keys passed through by the drag when a drop of the drag occurs on the text generating screen. The controller may execute an additional function set corresponding to a moving direction of the drag when the drag moves in a center area of the soft key pad in a predetermined direction, wherein the additional function comprises one of a spacing function, a backspace function, and a function for converting types of characters allotted to the soft keys.

An apparatus and a method according to aspects of the present invention for generating a text in a terminal enable a user to easily generate the text in the terminal. Specifically, because soft keys are elliptically arranged in the terminal, a terminal user may continuously and easily select soft keys to which desired characters are allotted. Accordingly, convenience for the user is enhanced. In addition, utility efficiency of the terminal is improved.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a block diagram illustrating a configuration of a terminal according to an exemplary embodiment of the present invention;

FIG. 2 is a flowchart illustrating a method for generating a text in a terminal according to an exemplary embodiment of the present invention;

FIG. 3 is a flowchart illustrating a procedure for executing a text generating mode in the method shown in FIG. 2 according to an exemplary embodiment of the present invention;

FIG. 4 to FIG. 6 are views illustrating examples of screens displayed upon executing the text generating mode procedure shown in FIG. 2 according to an exemplary embodiment of the present invention; and

FIG. 7 to FIG. 9 are views illustrating other examples of screens displayed upon executing the text generating mode procedure shown in FIG. 2 according to an exemplary embodiment of the present invention.

Throughout the drawings, like reference numerals will be understood to refer to like parts, components, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

As used herein, the term “character” means a visible mark for communication with a user. The character is classified according to a type thereof. That is, the character may be classified into, for example, English language, Korean language, Chinese language, Japanese language, numerals, and specific characters. As used herein, the term “ellipse” means a substantially ring-like figure formed of a closed curve. In this case, the ellipse includes a circle, but the present invention is not limited thereto. The ellipse may, for example, include a polygon comprising of a plurality of segments. Other variations are of course possible without departing from the scope and spirit of the disclosed invention.

As used herein, the term “touch” means that a terminal user touches on a touch screen, typically using a finger or stylus. As used herein, the term “drag” means an operation of moving the finger by the terminal user in a state that the terminal user maintains a touch on the touch screen, namely, contacts thereon with the finger. As used herein, the term “drop” means an operation of removing the finger that is touching, that is, currently contacting, a touch screen, from the touch screen.

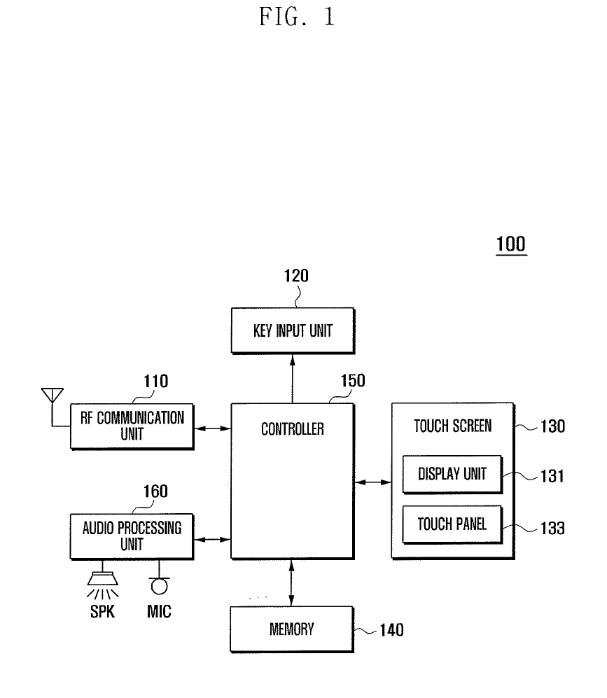

FIG. 1 is a block diagram illustrating a configuration of a terminal according to an exemplary embodiment of the present invention. It is assumed that a terminal is a mobile phone in this exemplary embodiment.

Referring to FIG. 1, a terminal 100 of this exemplary embodiment includes a Radio Frequency (RF) communication unit 110, a key input unit 120, a touch screen 130, a memory 140, a controller 150, and an audio processing unit 160.

The RF communication unit 110 executes an RF communication function of the terminal 100. The RF communication unit 110 includes an RF transmitter for up-converting a frequency of a signal for transmission and for amplifying the signal, and an RF receiver for low-noise-amplifying a received signal and for down-converting a frequency of the signal.

The key input unit 120 includes function keys for setting and executing various types of functions.

The touch screen 130 may include a display unit 131 and a touch panel 133. The display unit 131 displays a state of the terminal 100. In this exemplary embodiment, the display unit 131 is implemented in the form of an image output device such as a Liquid Crystal Display (LCD), and may include an image output device controller, a memory capable of storing display data, and an image display element. The touch panel 133 senses a touch on the display unit 131. The touch panel 133 is mounted on a surface of the display unit 131, and includes a touch sensor (not shown) and a signal converter (not shown). The touch sensor detects changes in a physical characteristic amount, for example, electrical resistance or capacitance, to detect the occurrence of the touch. Further, the signal converter converts the change in the physical characteristic amount into a touch signal.

The memory 140 may include a program memory and a data memory. The program memory stores programs for controlling a general operation of the terminal 100. The program memory may store programs for generating a text according to an exemplary embodiment of the present invention. The data memory executes a function of storing data created during execution of the programs. Moreover, the memory may store a soft key pad to which respective characters are allotted corresponding to a plurality of character types, according to an exemplary embodiment of the present invention.

The controller 150 executes a function of controlling an overall operation of the terminal 100. The controller 150 includes a data processor, including a transmitter for encoding and modulating a signal for transmission and a receiver for demodulating and decoding a received signal. The data processor may be configured by a Modulator-Demodulator (MODEM) and a Coder-Decoder (CODEC). The CODEC may include a data CODEC for processing packet data, and an audio CODEC for processing an audio signal such as speech. Moreover, the controller 150 may receive the touch signal from the signal converter to detect a touch, a drag, or a drop occurring on the touch panel 133.

In addition, the controller 150 displays a soft key pad on a text generating screen in a text generating mode according to an exemplary embodiment of the present invention. In this case, the controller 150 elliptically arranges soft keys to configure a soft key pad. Here, the controller 150 may separate and arrange soft keys into at least two ellipses in a form of concentric circles. Furthermore, upon detecting a drag on a text generating screen, the controller 150 determines at least one of the soft keys corresponding to the drag. That is, the controller 150 may determine at least one among the soft keys passed through by the drag.

The audio processing unit 160 plays an audio signal received from an audio CODEC of a data processor through a speaker SPK, and outputs an audio signal received through a microphone MIC to the audio CODEC of a data processor.

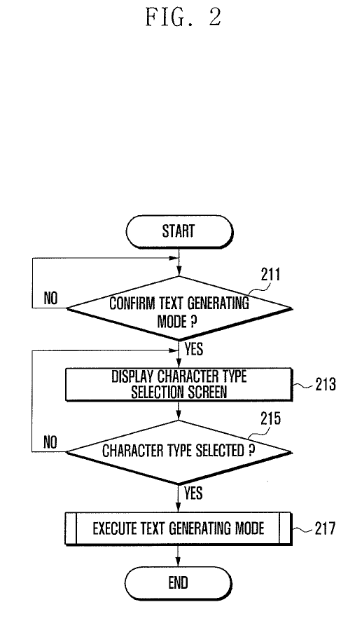

FIG. 2 is a flowchart illustrating a method for generating a text in a terminal according to an exemplary embodiment of the present invention.

Referring to FIG. 2, a controller 150 enters a text generating mode at step 211. That is, when a request for entering the text generating mode is detected, the controller 150 enters the text generating mode. Next, the controller 150 displays a character type selection screen at step 213. At this time, the controller 150 may display character types supported by the terminal 100. For example, the controller 150 may list character types such as English language, Korean language, Chinese language, Japanese language, numerals, and specific characters as a list. Subsequently, when any of the character types is selected, the controller 150 detects the selected type at step 215, executes a text generating mode at step 217, and terminates the text generating procedure. In this case, the controller 150 may continuously display the character type selection screen until one of the character types is selected. Further, the controller 150 may combine characters in a text generating mode to generate a text. Hereinafter, an exemplary procedure for performing a text generating mode by the controller 150 is described in detail.

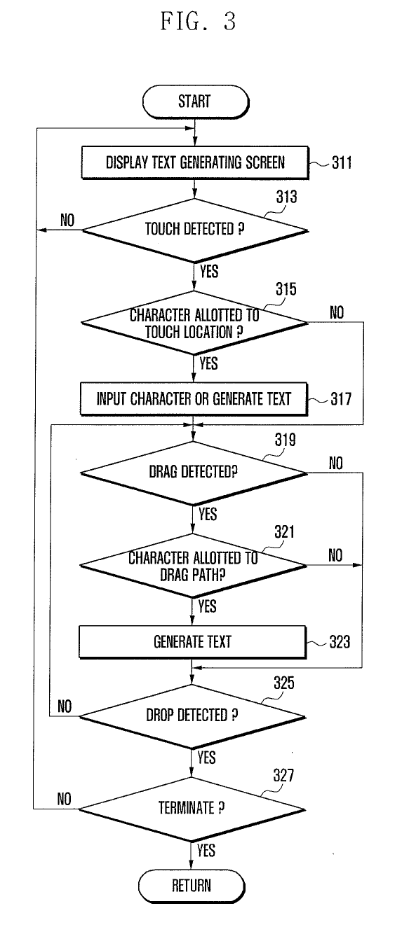

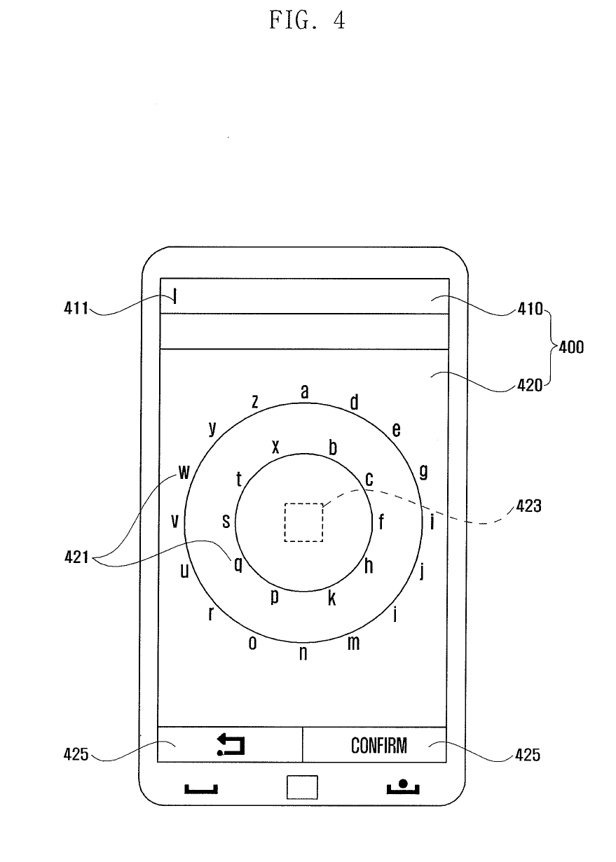

FIG. 3 is a flowchart illustrating a procedure for executing a text generating mode shown in FIG. 2 according to an exemplary embodiment of the present invention. FIG. 4 to FIG. 6 are views illustrating examples of screens displayed upon executing the text generating mode procedure shown in FIG. 2 according to an exemplary embodiment of the present invention. This exemplary embodiment is described such that the character type is English language characters.

Referring to FIG. 3, upon execution of the text generating mode, a controller 150 displays at step 311 a text generating screen 400 as shown in FIG. 4. In this case, the text generating screen 400 includes a text display window 410 and a soft key pad 420. Here, the controller 150 displays a cursor 411 indicating a location for displaying a character on the text display window 410. Further, the controller 150 elliptically arranges soft keys 421 to configure and display the soft key pad 420. Moreover, the controller 150 separately allots characters of a specific selected character type to soft keys 421. Specifically, the controller 150 separately allots characters corresponding to location coordinates of the soft keys 421.

In this case, the controller 150 may separate and arrange soft keys into at least two ellipses in a form of concentric circles. However, the controller 150 may arrange more soft keys 421 in an outer ellipse than in an inner ellipse in order to provide sufficient space for soft keys in their corresponding ellipses. For example, the controller 150 may allot characters configuring voiced sounds in the English language, namely, ‘a, d, e, g, i, j, l, m, n, o, r, u, v, w, y, z’, to outer soft keys 421. The controller 150 may further allot characters configuring voiceless sounds, namely, ‘b, c, f, h, k, p, q, s, t, x’, to inner soft keys 421. Alternatively, the controller 150 may allot characters arranged at a left side of a QWERTY board, for example, ‘q, w, e, r, t, y, a, s, d, f, g, h, z, x, c, v, b’, to the outer soft keys 421. The controller 150 may allot characters arranged at a right side of the QWERTY board, namely, ‘u, i, o, p, j, k, l, n, m’, to the inner soft keys 421. Various other arrangements are of course possible, such as an arrangement similar to an arrangement of a QWERTY keyboard, an arrangement in accordance with a frequency of character occurrence, or a custom arrangement in accordance with a user's preference, for example. The present invention is not limited to any particular arrangement of the characters to the inner and outer soft keys 421.

Furthermore, the controller 150 may activate a direction sensing area 423 for determining a moving direction of a drag in a center area of the soft key pad 420. In this case, the controller 150 may allot additional functions corresponding to specified moving directions. For example, the additional functions may include a spacing function, a backspace function, and a function for converting a current character type into another character type. Moreover, the controller 150 may further display at least one soft button 425 on the soft key pad 420. The controller may allot a function for stopping or terminating the generating of a text to the soft button 425 to terminate a text generating mode. Further, the controller 150 may allot a function for converting a current character type into another character type to the soft button 425.

Next, if a touch occurs on the text generating screen 400, the controller 150 detects the touch at step 313, and determines whether the touch corresponds to a soft key 421 at step 315. That is, the controller 150 determines location coordinates of the touch on the text generating screen 400 and determines whether a character is allotted to corresponding location coordinates. If the touch corresponds to a soft key 421 at step 315, the controller 150 generates a text with a character of the corresponding soft key 421 at step 317. That is, the controller 150 determines a character corresponding to the location coordinates of the touch and inputs the character as a part of the text. Further, the controller 150 displays the character at a location of the cursor 411 on the text display window 410. When a previously input character is currently displayed on the text display window 410, the controller 150 combines the newly input character with the previously displayed character to generate the text. Moreover, the controller 150 moves the cursor 411 to a location corresponding to an end of the text in the text display window 410.

If a drag occurs on the text generating screen 400, the controller 150 detects the drag at step 319, and determines whether the drag passes through the soft key 421 at step 321. That is, the controller 150 determines a moving path of the drag on the text generating screen 400, and determines whether a character is allotted on the corresponding moving path. If the drag passes through one or more of the soft keys 421 at step 321, the controller 150 generates a text with characters of the corresponding soft keys 421 at step 323. That is, the controller 150 determines characters corresponding to the location coordinates on a moving path of the drag and inputs the characters as a part of the text. Further, the controller 150 displays a character at a location of the cursor 411 on the text display window 410. Here, when a previously input character is currently displayed on the text display window 410, the controller 150 combines the newly input character with the previously displayed character to generate a text. Moreover, the controller 150 moves the cursor 411 to a location corresponding to an end of the text on the text display window 410.

In the meantime, although not shown, if the drag does not pass through a soft key 421 at step 321, the controller 150 may determine whether the drag passes through the direction sensing area 423. If the drag passes through the direction sensing area 423, the controller 150 may execute an additional function corresponding to a moving path or direction of the drag. That is, the controller 150 may determine a moving path of the drag on the text generating screen 400, and determines whether an additional function is allotted on the corresponding moving path. The moving path may include more than one direction, such as a circle, for example. In addition, the controller 150 may determine a moving direction of a drag in the direction sensing area 423 and execute an additional function corresponding to the moving direction.

In this case, the controller 150 may move a location of the cursor 411 on the text display window 410, edit some characters of a text, or convert a current character type into another character type. For example, when a drag moves in a rightward direction in the direction sensing area 423, the controller 150 may process the movement as a spacing function corresponding to the drag. When a drag moves in a leftward direction in the direction sensing area 423, the controller 150 may process the movement as a backspace function corresponding to the drag. When a drag moves in a downward direction in the direction sensing area 423, the controller 150 may convert a current character type into another character type, for example, a lower case letter of the English alphabet into an upper case letter of the English alphabet. Various other additional functions are of course possible.

Finally, if a drop occurs on the text generating screen 400, the controller 150 detects the drop at step 325, and maintains the text generating screen 400. In this case, the controller 150 continuously displays a text on the text display window 410. If a request for terminating the text generating mode is input while displaying the text generating screen 400, the controller 150 receives the request and terminates the text generating mode at step 327, and the process returns to FIG. 2.

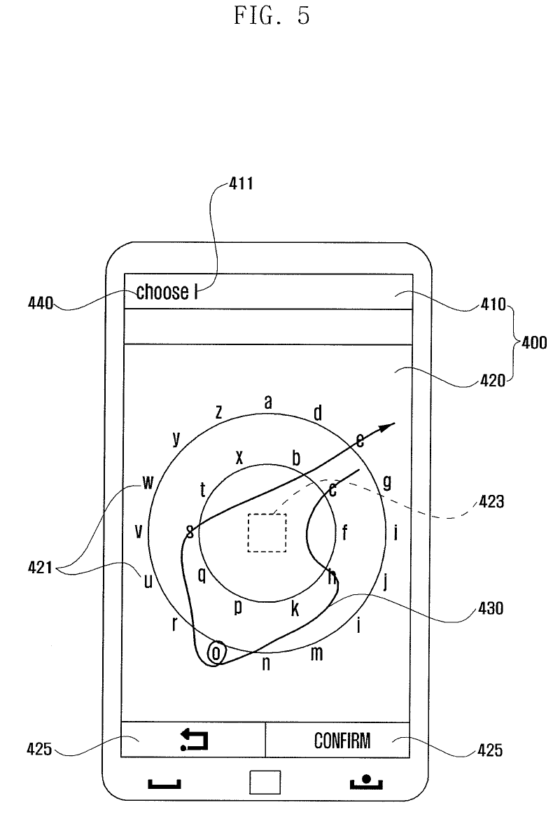

If a drop is not detected at step 325, the controller 150 repeats step 319 to step 325. At this time, the controller 150 combines characters on a moving path 430 of a drag as shown in FIG. 5 to generate a text 440. That is, when multiple characters are allotted on the moving path 430 of a drag, the controller 150 sequentially detects characters according to a moving path 430 of the drag. Here, when the moving path 430 of a drag is elliptically formed on a specific soft key 421, for example, ‘o’, the controller 150 may repetitively determine a character of a corresponding soft key 421. Next, the controller 150 combines the corresponding characters to generate a text 440. Furthermore, the controller 150 displays a character at a location of the cursor 411 on the text display window 410. Here, when a previously input character is currently displayed on the text display window 410, the controller 150 combines the newly input character with the previously displayed character to generate the text 440. For example, the controller 150 sequentially detects ‘c, h, o, o, s, e’ according to a moving path 430 of a drag, combines the characters as the word ‘choose’, and displays it on the text display window 410 as the text 440. In addition, the controller 150 moves the cursor 411 to a location corresponding to an end of the text 400 on the text display window 410.

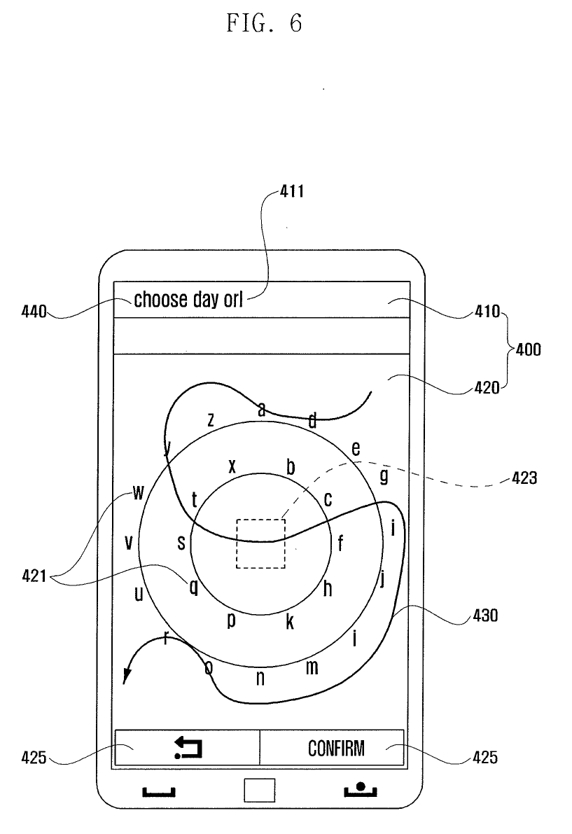

If a request for terminating the text generating mode is not received at step 327, the controller 150 repeats step 311 to step 327. At this time, as shown in FIG. 6, the controller 150 combines characters corresponding to location coordinates of a touch or a moving path 430 of a drag to generate the text 440. That is, when a touch occurs at a soft key 421 on the text generating screen 400 or a drag occurs passing through the soft key 421, the controller 150 sequentially determines characters. Subsequently, the controller 150 combines corresponding characters to generate a text 440. Further, the controller 150 displays a character at a location of a cursor 411 on the text display window 410. Here, when a previously input character is currently displayed on the text display window 410, the controller 150 combines the character displayed at the location of a cursor 411 with the previously displayed character to generate a text 440. For example, the controller 150 may sequentially detect ‘d, a, y, o, r’ according to a moving path 430 of a drag as shown in FIG. 6, and combines ‘choose’ with ‘day or’ to display it on the text display window 410 as the text 440. In addition, the controller 150 moves a cursor 411 to a location corresponding to an end of the text 440.

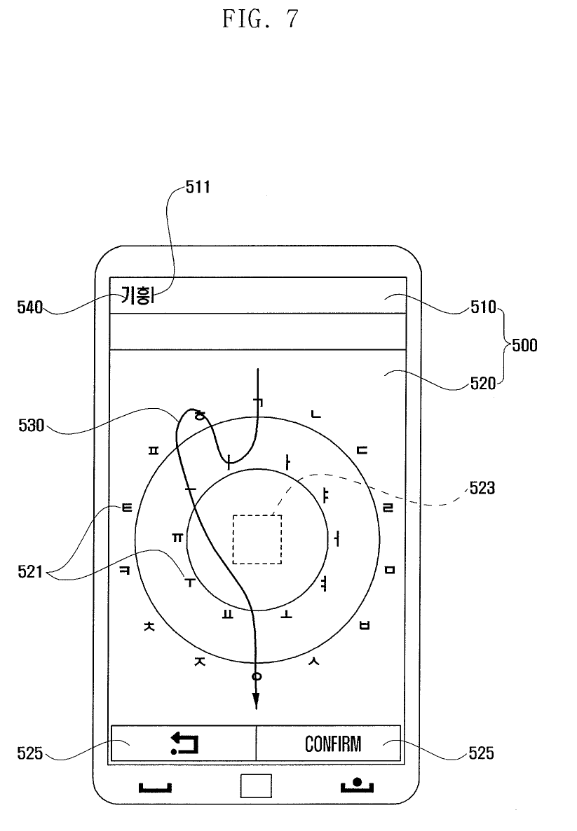

The foregoing exemplary embodiment has described a case where a character type is in the English language. However, the present invention is not limited thereto. The foregoing exemplary embodiment illustrated the soft key pad 420 composed of two ellipses. However, the present invention is not limited thereto. FIG. 7 to FIG. 9 are views illustrating other examples of screens displayed upon executing a text generating mode procedure as shown in FIG. 2.

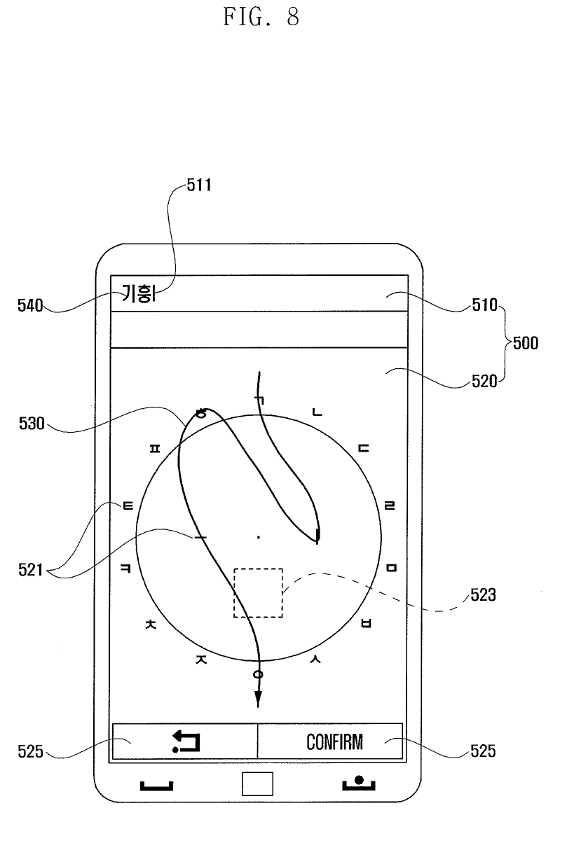

That is, when a character type is the Korean language, the controller 150 displays a text generating screen 500, as shown in FIG. 7 and FIG. 8 at step 311. In this case, the text generating screen 500 includes a text displaying window 510 and a soft key pad 520. Here, the controller 150 displays a cursor 511 indicating a location for displaying a character on the text display window 510. Moreover, the controller 150 elliptically arranges soft keys 521 to configure and display the soft key pad 520. Further, the controller 150 separately allots characters corresponding to a specific selected character type to the soft keys 521. Namely, the controller 150 separately allots characters corresponding to location coordinates of the soft keys 521. The controller 150 may elliptically arrange a portion of the soft keys 521 and arrange remaining soft keys 521 in a line at a center area, as shown in FIG. 8. Alternatively, the controller 150 may arrange more soft keys 521 in an outer ellipse than in an inner ellipse or a center area in order to provide spaces for respective soft keys 521 in their corresponding ellipses. For example, the controller 150 may allot characters corresponding to consonants in the Korean language, namely, ‘ [symbol] [symbol] [symbol] ’, to outer soft keys 521. Further, the controller 150 may allot characters corresponding to vowels in the Korean language, namely, ‘ [symbol] [symbol] , [symbol] ’, to inner soft keys 521, as shown in FIG. 7. Alternatively, the controller 150 may allot characters corresponding to elements corresponding to vowels in Korean language, namely, ‘ [symbol] , . . . , 1’, to the inner soft keys 521, as shown in FIG. 8.

Furthermore, the controller 150 may activate a direction sensing area 523 for determining a moving direction of a drag at a center area of the soft key pad 520. In this case, the controller 150 may allot additional functions according to specified moving directions. For example, the additional functions may include a spacing function, a backspace function, and a function for converting a current character type into another character type. Moreover, the controller 150 may further display at least one soft button 525 on the soft key pad 520. The controller may allot a function for stopping or terminating generating a text to terminate a text generating mode to the soft button 525. Further, the controller 150 may allot a function for converting a current character type into another character type to the soft button 525.

Further, the controller 150 may repeat step 311 to step 327 to execute a text generating mode. In this case, as shown in FIG. 7 and FIG. 8, the controller 150 combines characters on location coordinates of a touch or a moving path 530 of a drag to generate a text 540. Namely, when a touch occurs at the soft key 521 on the text generating screen 500 or a drag occurs passing through the soft key 521, the controller 150 sequentially determines characters. Next, the controller 150 combines corresponding characters to generate the text 540. Furthermore, the controller 150 displays a character at a location of a cursor 511 on the text display window 510. Here, when a previously input character is currently displayed on the text display window 510, the controller 150 combines the character displayed at the location of the cursor 511 with the previously displayed character to generate the text 540. For example, the controller 150 sequentially detects ‘ [symbol] ’ according to a moving path 530 of a drag, and combines them as ‘ [symbol] ’ and displays the characters ‘ [symbol] ’ on the text display window 510 as the text 540. In addition, the controller 150 moves a cursor 511 to a location corresponding to an end of the text 540 on the text display window 510. Here, the controller 150 may form one syllable corresponding to one touch operation composed of a touch, a drag, and a drop.

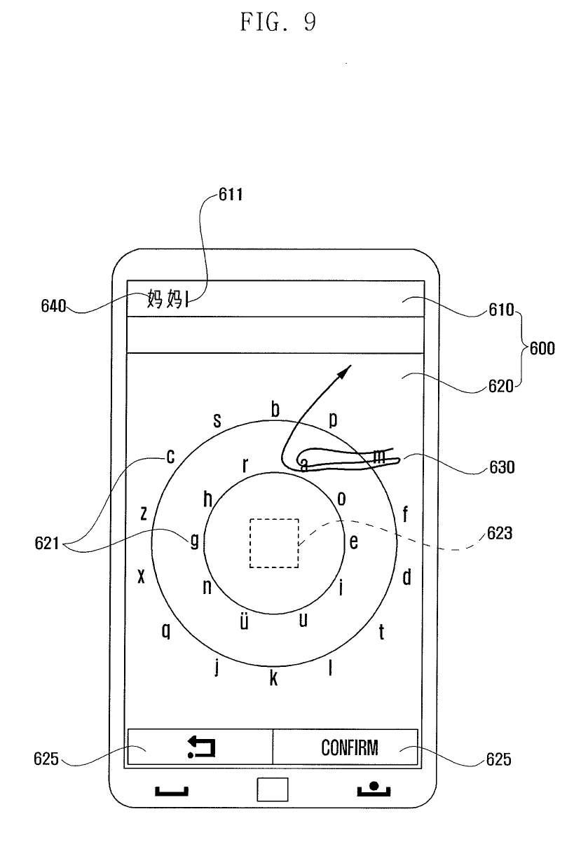

Alternatively, if the character type is a Chinese language, the controller 150 displays a text generating screen 600 as shown in FIG. 9 at step 311. In this case, the text generating screen 600 includes a text display window 610 and a soft key pad 620. Here, the controller 150 displays a cursor 611 indicating a location for displaying a character on the text display window 610. Moreover, the controller 150 elliptically arranges soft keys 621 to configure and display a soft key pad 620. Further, the controller 150 separately allots characters corresponding to a specific selected character type to the soft keys 621. Specifically, the controller 150 separately allots characters corresponding to location coordinates of the soft keys 621.

For reference, the Chinese language is expressed with the use of more than one hundred-thousand Chinese characters. Simplified Chinese is used to improve convenience in China, and Chinese pinyin is used to input Chinese characters in the terminal. In this case, Chinese pinyin represents a pronunciation sign indicating pronunciations of Chinese character elements as Roman letters. Furthermore, the Chinese pinyin is composed of 21 Chinese consonants and 36 Chinese vowels. The Chinese consonant represents a consonant of a syllable, and the Chinese vowel represents a vowel that is combined with a consonant of a syllable or may be used in the syllable without the Chinese consonant. Here, the Chinese consonants are described in Table 1, and the Chinese vowels are described in Table 2 and Table 3. That is, all pronunciations of Chinese letters may be expressed by a combination of consonants and at least one Chinese vowel, or a combination of plural Chinese vowels as in the Chinese combination vowels of Table 3. Here, the latter are pronunciations composed of Chinese vowels without Chinese consonants.

TABLE 1

| Chinese consonant | Chinese pinyin |
|---|---|
| Double labial sound | b p m |
| Labiodental sound | f |
| Apical sound | d t n |
| Lingual root sound | g k h |
| Dorsal sound | j q x |
| Retroflex | zh ch sh r |
| Apico-dental | z c s |

TABLE 2

| | |
|---|---|
| Chinese vowel | Chinese pinyin |

| | | |
|---|---|---|
| General | Short vowel | a o e i U ü |
| vowel | Double vowel | ai ei ao ou |
| | Attach sound vowel | an en ang eng ong |
| | Retroflex vowel | er |

| | |
|---|---|
| Combination vowel | ia ie iao iu ian in iang ing iong |
| | ua uo uai ui uan un uang ueng |
| | üe üan ün |

TABLE 3

| | | Teeth contact | | Composite | | Photo-mouth | |
|---|---|---|---|---|---|---|---|
| | | sound | | mouth sound | | sound | |
| Combination | | I | | U | | Ü | |
| vowel | | I | Yi | u | Wu | Ü | Yu |
| Short | A | Ia | Ya | ua | Wa | | |
| vowel | O | | Yo | uo | Wo | | |
| | E | Ie | Ye | | | Üe | yue |
| Double | Ai | | | uai | Wai | | |
| vowel | Ei | | | ui | Wei | | |
| | Ao | Iao | Yao | | | | |
| | Ou | Iu | You | | | | |
| Attach | An | Ian | Yan | uan | Wan | Üan | yuan |
| sound | En | In | Yin | un | Wen | Ün | yun |
| vowel | Ang | Iang | Yang | uang | wang | | |
| | Eng | Ing | Ying | ueong | weng | | |
| | Ong | Iong | Yong | | | | |

In this case, the controller 150 may separate and arrange soft keys on the text generating screen 600 into at least two ellipses in the form of concentric circles. However, the controller 150 may arrange more soft keys 621 in an outer ellipse than in an inner ellipse in order to provide spaces for their corresponding soft keys in respective ellipses. For example, the controller 150 may allot characters corresponding to Chinese consonants in the Chinese language, namely ‘b, p, m, f, d, t, n, l, g, k, h, j, q, x, z, c, s, r’, to outer soft keys 621. The controller 150 may allot characters corresponding to Chinese vowels, namely, ‘a, o, e, i, u, ü’, to inner soft keys 621. The controller 150 may further allot characters configurable by Chinese vowels among characters configuring elements configuring Chinese consonants in the Chinese language, namely, ‘n, g, h, r’, to the inner soft keys 621.

Furthermore, the controller 150 may activate a direction sensing area 623 for determining a moving direction of a drag at a center area of a soft key pad 620. In this case, the controller 150 may allot additional functions corresponding to respective moving directions. For example, the additional function may include a spacing function, a backspace function, a function for converting a current character type into another character type, and an intonation input function of Chinese letters. Moreover, the controller 150 may further display at least one soft button 625 on the soft key pad 620. At this time, the controller may allot a function for stopping or terminating generating a text to the soft button 625 to terminate a text generating mode. Further, the controller 150 may allot to the soft button 625 a function for converting a current character type into another character type.

In addition, the controller 150 may repeat step 311 to step 327 to execute a text generating mode. In this case, as shown in FIG. 9, the controller 150 combines characters corresponding to location coordinates of a touch or a moving path 630 of a drag with each other to generate the text 640. That is, when a touch occurs at a soft key 621 on the text generating screen 600 or a drag occurs passing through a soft key 621, the controller 150 sequentially determines characters. Subsequently, the controller 150 combines corresponding characters to generate a text 640. Further, the controller 150 displays a character at a location of a cursor 611 on the text display window 610. Here, when a previously input character displayed on the text display window 610, the controller 150 combines the character displayed at the location of a cursor 411 with the previously displayed character to generate a text 640. For example, the controller 150 sequentially detects ‘m, a, m, a’, according to a moving path 630 of a drag, and combines them as [symbol] to display it on the text display window 610 as the text 640. In addition, the controller 150 moves a cursor 611 to a location corresponding to an end of the text 640. Here, the controller 150 may form one syllable corresponding to one touch operation composed of a touch, a drag, and a drop.

This exemplary embodiment has described a case where the controller 150 inputs the Chinese language using Chinese pinyin. However, the present invention is not limited thereto. For example, the controller 150 may input the Chinese language using phonetic symbols, and the present invention is also applicable thereto. In this case, an input method using phonetic symbols is a method that selects and inputs keys on which Chinese representative letters with the same pronunciation are expressed. The phonetic symbols are composed of 21 Chinese consonants and 38 Chinese vowels. Here, Table 4 lists the Chinese consonants, and Table 5 and Table 6 list the Chinese vowels.

TABLE 4

| | Phonetic | |
|---|---|---|
| Chinese consonant | symbol | Chinese pinyin |
| Middle roundness | [symbol] | B |
| | [symbol] | P |
| | [symbol] | M |
| Labiodental | [symbol] | F |
| Apical | [symbol] | D |
| | [symbol] | T |
| | [symbol] | N |
| | [symbol] | L |
| Lingual root | [symbol] | G |
| | [symbol] | K |
| | [symbol] | h |
| Dorsal | [symbol] | j |
| | [symbol] | q |
| | [symbol] | x |
| Cross apical | [symbol] | zh |
| | [symbol] | ch |
| | [symbol] | sh |
| | [symbol] | r |
| Apico-dental | [symbol] | z |
| | [symbol] | c |
| | [symbol] | s |

TABLE 5

Chinese pinyin

| | Phonetic | | Consonant |
|---|---|---|---|
| General vowel | symbol | No consonant | presence |
| Short vowel | [symbol] | a | |
| | [symbol] | o | |
| | [symbol] | e | |
| | [symbol] | ê | |
| | [symbol] | yi | (i) |
| | [symbol] | wu | (u) |
| | [symbol] | yu | (ü) |
| Double vowel | [symbol] | ai | |
| | [symbol] | ei | |
| | [symbol] | ao | |
| | [symbol] | ou | |
| Attach | [symbol] | an | |
| sound | [symbol] | en | |
| vowel | [symbol] | ang | |
| | [symbol] | eng | |
| Retroflex vowel | [symbol] | er | (r) |

TABLE 6

| | Phonetic | Chinese pinyin | |
|---|---|---|---|
| Combination vowel | symbol | No consonant | Consonant presence |
| Teeth contact type | [symbol] | ya | (ia) |
| | [symbol] | yo | |
| | [symbol] | ye | (ie) |
| | [symbol] | yai | |
| | [symbol] | yao | (iao) |
| | [symbol] | you | (ou, iu) |
| | [symbol] | yan | (ian) |
| | [symbol] | yin | (in) |
| | [symbol] | yang | (iang) |
| | [symbol] | ying | (ing) |
| Composite | [symbol] | wa | (ua) |
| mouth type | [symbol] | Wo | (uo) |
| | [symbol] | Wai | (uai) |
| | [symbol] | Wei | (iu) |
| | [symbol] | Wan | (uan) |
| | [symbol] | Wen | |
| | [symbol] | Wang | (uang) |
| | [symbol] | Weng | (ong) |
| Photo- | [symbol] | Yue | (ue) |
| mouth type | [symbol] | Yuan | (uan) |
| | [symbol] | Yun | (un) |
| | [symbol] | Yong | (iong) |

The foregoing exemplary embodiment has illustrated a case where a direction sensing area is arranged at a center area of a soft key pad. However, the present invention is not limited thereto. That is, soft buttons to which corresponding additional functions are allotted may be disposed at a center area of the soft key pad to implement the present invention.

The present invention enables easy generation of a text in various languages. Since soft keys are elliptically arranged in a terminal, a terminal user may continuously select respective soft keys to which desired characters are allotted. This improves convenience for a user of the terminal. In addition, the present invention enhances utilization efficiency of the terminal.

While the invention has been shown and described with reference to certain exemplary embodiments thereof, it will be understood by those skilled in the art that various changes in form and details may be made therein without departing from the spirit and scope of the invention as defined in the appended claims and their equivalents.

What is claimed is:

1. A method for generating a text in a terminal, the method comprising:
displaying a soft key pad comprising soft keys on a text generating screen while in a text generating mode, the soft keys being elliptically arranged in a ring arrangement on the soft key pad; and
generating a text comprising a character allotted to a soft key through a dragging motion when a drag path of the dragging motion is determined to pass through the soft key.

2. The method of claim 1, wherein the displaying of the soft key pad comprises separating and arranging soft keys into at least two rings in a form of concentric circles.

3. The method of claim 1, wherein the displaying of the soft key pad comprises spacing the soft keys apart from each other to provide a passing area of the drag path between the soft keys.

4. The method of claim 1, wherein the generating of the text comprises generating the text comprising a character allotted to a selected soft key when a touch for selecting the soft key is detected from the soft key pad.

5. The method of claim 1, wherein the generating of the text comprises generating a word comprising characters allotted to soft keys passed through on the drag path when a drop of the dragging motion occurs on the text generating screen; and
repeating the generating of another text when another dragging motion occurs on the soft key pad.

6. The method of claim 1, wherein the generating of the text comprises executing an additional function set corresponding to a moving direction of the drag path when the dragging motion moves in a center area of the soft key pad in a predetermined direction, wherein the additional function set comprises a spacing function, a backspace function, and a function for converting types of characters allotted to the soft keys.

7. An apparatus for generating a text in a terminal, the apparatus comprising:
a display unit for displaying a soft key pad comprising soft keys on a text generating screen while in a text generating mode, the soft keys being elliptically arranged in a ring arrangement on the soft key pad;
a touch panel for detecting a drag passing through at least one of the soft keys; and
a controller for generating a text comprising a character allotted to a soft key passed through by a drag.

8. The apparatus of claim 7, wherein the display unit separates and arranges the soft keys into at least two rings in a form of concentric circles under control of the controller.

9. The apparatus of claim 7, wherein the display unit spaces the soft keys apart from each other to provide a passing area for the drag between the soft keys.

10. The apparatus of claim 7, wherein the controller generates the text comprising a character allotted to a selected soft key when a touch for selecting the soft key is detected from the soft key pad.

11. The apparatus of claim 7, wherein the controller creates a word comprising characters allotted to soft keys passed through by the drag when a drop of the drag occurs on the text generating screen.

12. The apparatus of claim 7, wherein the controller executes an additional function set corresponding to a moving direction of the drag when the drag moves in a center area of the soft key pad in a predetermined direction, wherein the additional function set comprises a spacing function, a backspace function, and a function for converting types of characters allotted to the soft keys.
